(19) United States
(12) Patent Application Publication
(10) Pub. No.: US 2013/0046543 A1
(43) Pub. Date: Feb. 21, 2013

(54) INTERACTIVE VOICE RESPONSE (IVR) SYSTEM FOR ERROR REDUCTION AND DOCUMENTATION OF MEDICAL PROCEDURES

(71) Applicants: Judy Kitchens, Austin, TX (US); Frank Mazza, Austin, TX (US)

(72) Inventors: Judy Kitchens, Austin, TX (US); Frank Mazza, Austin, TX (US)

(73) Assignee: Seton Healthcare Network

(21) Appl. No.: 13/554,469

(22) Filed: Jul. 20, 2012

Related U.S. Application Data
(60) Provisional application No. 61/510,775, filed on Jul. 22, 2011.

(51) Int. Cl. G10L 11/00

(52) U.S. Cl. 704/270.1; 704/E11.001

(57) ABSTRACT

Interactive voice response (IVR) systems and methods for delivery of healthcare services (e.g., by one or more medical professionals, such as, for example, in a hospital or clinic). In some embodiments, the present systems can be configured to: prompt one or more users for a plurality of voice inputs with information associated with at least one of a patient and a user; and determine whether each of the plurality of voice inputs is consistent with records related to the patient or the one or more users. In some embodiments, the present systems can be configured to: during performance of a procedure on a patient, prompt one or more users to provide a plurality of voice inputs with information related to progress of the procedure or characteristics of the patient; and/or prompt the user to perform each of a plurality of steps of the procedure.

### CROSS-REFERENCE TO RELATED APPLICATIONS

This application claims priority to U.S. Provisional Patent Application No. 61/510,775 filed Jul. 22, 2011, which is incorporated by reference in its entirety.

### BACKGROUND

1. Field of the Invention

The present invention relates generally to tools and methods for improving the delivery of healthcare. More particularly, but not by way of limitation, the present invention relates to methods and systems utilizing interactive voice response (IVR) technology for receiving and verifying information, and/or providing and verifying performance of procedure instructions, in substantially real-time, in connection with the provision of healthcare.

2. Background Information

Electronic systems, some including voice recognition technology, have been used for certain purposes in the medical field, such as, for example, to collect information for medical records and to display instructions for performing medical procedures. An example of a system for clinical documents management by vocal interaction may be found in Pub. No. US 2009/0132276. An example of a device that provides voice activated decision support suitable for persons who are not medical professionals can be found in US 2006/0223042.

### SUMMARY

The present disclosure includes embodiments of systems and methods for interactive voice response (IVR) support for the provision of healthcare (e.g., medical procedures, preparation of medical records, etc.), such as, for example, by one or more healthcare professionals (physicians, nurses, physician assistants, technicians, administrators, etc.).

Some embodiments of the present systems are computerized, and include hardware and software enabling interaction with a user via interactive voice response (IVR) technology, such as, for example, to receive and verify (or validate) information, provide instructions and verify performance of procedure instructions to healthcare professionals to minimize human errors and improve patient safety. For example, embodiments of the present systems can be configured for directing and/or distributing tasks among a team of healthcare professionals with one or multiple patients (e.g., to improve the likelihood of multiple healthcare professionals working smoothly as a team). Some embodiments of the present systems and methods include “artificial intelligence” functionality (e.g., incorporating elements of human factors engineering and cognitive psychology) that can provide reminders of clinical “forcing functions,” redundancies and cross-checks, rejections of irrelevant or inaccurate information, and/or automatic recording interventions and updates in chronological order. Embodiments of the present systems may also serve as a crew resource manager providing communication among multiple professionals and give timing elapse alerts in crisis situations. Embodiments of the present systems may include software installed on one or more computers or computer systems, that may, for example, be accessed via a mobile computer or stationary computers installed in operating rooms and/or patient rooms, to interact with healthcare providers and guide them to minimize chances that human error will lead to patient harm.

Functions included in and/or provided by embodiments of the present systems can include any one or more of the following examples.

Verifying the nature of procedures or medication by confirming any one or more of: procedure/medication name (“Please state the name of procedure!”); patient information and diagnosis (“Patient medical record number is ______, DOB is ______”); site/dosage (“Please confirm procedure site: left inguinal region.”); frequency of administration of medication and/or procedure (“Please verify the timing of last medication administration and the dosage.”); pre-assessment/treatment (“Antibiotics given?”).

Detecting gaps and mismatches by clarifying any one or more of: misunderstandings (“Incorrect dosage. Please try again!”); mis-reading/mis-interpretations (“Patient and procedure match not found. Please try again!”); mis-statements (“I did not hear you. Please repeat!”); misjudgments (“Is everyone on the same page?” or “Does everyone agree?”).

Maintaining mindfulness by addressing any one or more of: sensory illusions created by adrenalin rush (“Let me read back from the chart: patient's name is ______, medical record number ______, DOB ______, procedure name ______” Are they correct?); temporary memory blackout caused by stress/fatigue (“Do you anticipate blood loss of more than a half liter?”); negligence of timing (“It is now 3 minutes after the shoulder dystocia call!”); loss of team awareness (“Is the team in the room? Please identify your roles.”).

Enhancing situational awareness by alerting any one of: equipment failures (“Normal response not detected. Please notify your charge nurse!”); emergency situations (“Code blue called. It is now 7:15 a.m.”); timing awareness (“Time is running out, you are at the end of 5-minute window time! Please activate your emergency protocol!”).

Some embodiments of the present systems comprise: a memory; a processor coupled to the memory; and a user interface coupled to the processor, the user interface configured to receive voice inputs from a user; where the system is configured to: prompt one or more users for a plurality of voice inputs with information associated with at least one of a patient and a user; and determine whether each of the plurality of voice inputs is consistent with records related to the patient or the one or more users.

In some embodiments, the information related to a patient includes at least one of: an alphanumeric patient identifier associated with the patient, the patient's name, the patient's birthdate, and one or more physical characteristics of the patient. In some embodiments, the system is configured to: prompt one or more users for voice input with information associated with each of a plurality of users. In some embodiments, the system is configured to identify which of a plurality of users provided a voice input. In some embodiments, the system is configured to: receive a voice input from each of a plurality of users; and generate for each of the plurality of users a voice print corresponding to the user and configured to be compared to a subsequent voice input to identify the user that provided the subsequent voice input.

In some embodiments, the information associated with the one or more users includes at least one of: an alphanumeric identifier associated with a medical professional, a medical professional's name, and a medical professional's title. In some embodiments, the system is configured to: prompt one or more users for one or more voice inputs with a procedure to be performed on the patient. In some embodiments, the system is configured to: determine whether the indicated procedure is consistent with a planned procedure stored in a record related to the patient; and if the procedure indicated is not consistent, prompt the one or more users for one or more additional voice inputs with the procedure. In some embodiments, the system is configured to: prompt the one or more users for one or more voice inputs with a reason for the procedure.

In some embodiments, the system is configured to: prompt one or more users for one or more voice inputs with information relating to whether a procedure should be performed on the patient. In some embodiments, the prompted information includes patient characteristics. In some embodiments, the system is configured to: determine whether the information indicates that the procedure should be performed; and if the information indicates that the procedure should not be performed on the patient, alert the provider that the information indicates that the procedure should not be performed.

In some embodiments, the system is configured to: during performance of a procedure on the patient, prompt the user to provide a plurality of voice inputs with information related to progress of the procedure or characteristics of the patient. In some embodiments, the system is configured to: evaluate whether the information related to progress of the procedure or characteristics of the patient indicates that the procedure should be modified or terminated. In some embodiments, the system is configured to: prompt one or more users to perform each of a plurality of steps of the procedure on a patient. In some embodiments, the system is configured to: prompt the user to modify or terminate the procedure if the information related to progress of the procedure or characteristics of the patient indicate that the procedure should be modified or terminated.

Some embodiments of the present systems comprise: a memory; a processor coupled to the memory; and a user interface coupled to the processor, the user interface configured to receive voice inputs from a user; where the system is configured to: during performance of a procedure on a patient, prompt one or more users to provide a plurality of voice inputs with information related to progress of the procedure or characteristics of the patient. In some embodiments, the system is configured to: prompt the user to perform each of a plurality of steps of the procedure. In some embodiments, the system is configured to: evaluate whether the information related to progress of the procedure or characteristics of the patient indicates that the procedure should be modified or terminated. In some embodiments, the system is configured to: if the information indicates that the procedure should be modified, prompt the user to perform a modified procedure; and if the information indicates that the procedure should be terminated, evaluate whether the information indicates that an alternate procedure should be performed.

In some embodiments, the system is configured to: if the information indicates that an alternate procedure should be performed, and that more than one alternate procedures may be indicated, prompt one or more users to provide a voice input with an alternate procedure to be performed; and if the information indicates that an alternate procedure should be performed, and that only one alternate procedure is indicated, prompt one or more users to perform the alternate procedure. In some embodiments, the system is configured to: evaluate whether the information indicates and alarm condition; and if the information indicates an alarm condition that indicates a need for one or more resources that are not present, communicate a request for the one or more resources. In some embodiments, the resource includes at least one of a medical professional, an operating room, and a medication. In some embodiments, the system is configured to: prompt one or more users for voice input with information associated with each of a plurality of users. In some embodiments, the system is configured to identify which of a plurality of users provided a voice input. In some embodiments, the system is configured to: receive a voice input from each of a plurality of users; and generate for each of the plurality of users a voice print corresponding to the user and configured to be compared to a subsequent voice input to identify the user that provided the subsequent voice input.

In any embodiment of the present disclosure, the term “substantially” may be substituted with “within [a percentage] of” what is specified, where the percentage includes 5, 10, and/or 15 percent.

Any embodiment of any of the present systems and/or methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 is a schematic block diagram illustrating one of the present systems.

FIG. 2 is a schematic block diagram illustrating a database suitable for use in some of the present systems.

FIG. 3 is a schematic block diagram illustrating one embodiment of a computer suitable for use with or in at least some of the present systems.

FIG. 4 depicts a schematic block diagram illustrating one embodiment of an apparatus suitable for use with or in some of the present systems.

FIGS. 5A-5E depict a flowchart of one embodiment of the present methods, including functions that can be included in embodiments of the present systems.

### DESCRIPTION OF ILLUSTRATIVE EMBODIMENTS

The term “coupled” is defined as connected, although not necessarily directly, and not necessarily mechanically; two items that are “coupled” may be integral with each other. The terms “a” and “an” are defined as one or more unless this disclosure explicitly requires otherwise. The terms “substantially,” “approximately,” and “about” are defined as largely but not necessarily wholly what is specified, as understood by a person of ordinary skill in the art.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method that “comprises,” “has,” “includes” or “contains” one or more steps possesses those one or more steps, but is not limited to possessing only those one or more steps. Likewise, a watering system that “comprises,” “has,” “includes” or “contains” one or more elements possesses those one or more elements, but is not limited to possessing only those elements. For example, in a watering system that comprises one or more surfaces and a platform, the watering system includes the specified elements but is not limited to having only those elements. For example, such a watering system could also include a drainage structure.

Further, a device or structure that is configured in a certain way is configured in at least that way, but it can also be configured in other ways than those specifically described.

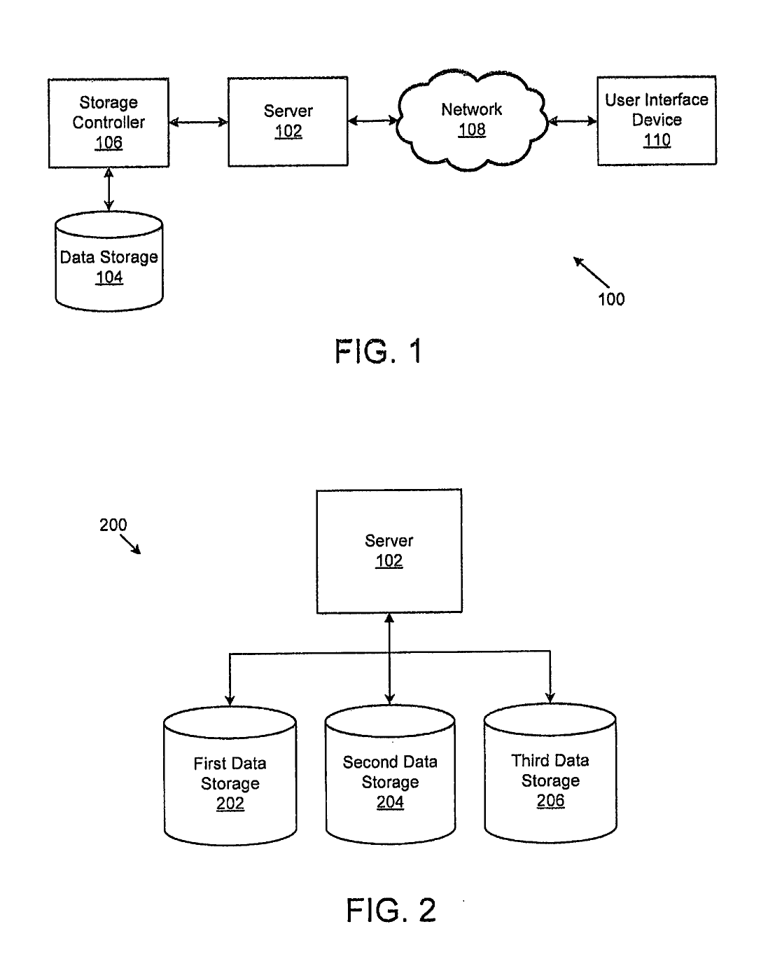

FIG. 1 conceptually illustrates one embodiment of a system 100 that can be used to implement at least some of the present embodiments. System 100 may include a server 102, a data storage device 104, a network 108, and a user interface device 110. In some embodiments, server 102 may include storage device 104 (e.g., a server housing or enclosure may house storage device 104). In some embodiments, system 100 may include a storage controller 106, and/or a storage server configured to manage data communications between data storage device 104 and server 102 and/or other components in communication with network 108. In some embodiments, storage controller 106 may be coupled to network 108 (e.g., such that server 102 communicates or is configured to communicate with storage controller 106 and/or storage device 104 via network 108. In a general embodiment, system 100 may be configured to store data (e.g., patient health records, healthcare provider records, medical procedure records, etc.). In some embodiments, system 100 is configured to permit multiple uses and/or functions to or with the data. For example, in some embodiments, system 100 is configured to permit multiple users (e.g., healthcare professional) to interact with the system simultaneously (e.g., a first healthcare professional verifying a patient's identity and/or procedure, a second healthcare professional performing a medical procedure on a patient with substantially real-time assistance from the system, etc.).

In some embodiments, server 102 is configured to access data stored in data storage device(s) 104 via a Storage Area Network (SAN) connection, a LAN, a data bus, or the like. Data storage device 104 may include a hard disk, including hard disks arranged in an Redundant Array of Independent Disks (RAID) array, a tape storage drive comprising a magnetic tape data storage device, an optical storage device, or the like. In one embodiment, data storage device 104 stores various types of data, as described in more detail below. In some embodiments, server 102 and/or storage device(s) 104 are configured to create a back-up (full and/or partial back-up) of the data.

In some embodiments, user-interface device 110 is referred to broadly and comprises a suitable processor-based device such as, for example, a desktop computer, a laptop computer, a Personal Digital Assistant (PDA), and/or a mobile communication or organizer device (e.g., a cellular phone, smartphone, etc.) having access to the network 108. In some embodiments, user interface device 110 can be configured to access the Internet to access a web application or web service hosted by server 102 and thereby provide a user interface for enabling a user to enter or receive information (e.g., from server 102). For example, user may receive or view, via user interface device 110, a webpage or an application screen (e.g., server 102 can transmit instructions to user interface device 110 to instruct or cause the user interface device to render a webpage or application screen). By way of further example, in some embodiments, user interface device 110 can be configured to receive from a user (e.g., via user-input, such as a microphone, keyboard, mouse, touchscreen, and/or the like), can be configured to prompt (e.g., audibly and/or visually) a user for (e.g., server 102 can be configured to instruct user-interface device 110 to prompt a user for), and/or can be configured to transmit to server 102 (e.g., via network 108), instructions (e.g., a voice input with or indicative of information). For example, user interface device 110 can audibly and/or visually prompt a user for a voice input.

Network 108 may facilitate communications of data between server 102 and user interface device 110. Network 108 may include any type of communications network including, but not limited to, a direct PC to PC connection, a local area network (LAN), a wide area network (WAN), a modem to modem connection, the Internet, a combination of the above, or any other communications network now known or later developed within the networking arts which permits two or more computers to communicate, one with another.

In some embodiments, the functions described in this disclosure may be performed by server 102 (e.g., user interface device 110 may provide a terminal for accessing the computing/processing function of the server); may be performed by server 102 and user interface device 110 (e.g., server 102 may perform some processing and user interface device 110 may perform some processing); or may be performed entirely by user interface device 110. For example, in some embodiments, a patient's medical records (and/or certain medical procedure software modules) may be downloaded to a user interface device 110 before beginning a planned procedure, such that all functions of the present system may be performed throughout the procedure without depending on a connection to server 102 via network 108.

FIG. 2 illustrates one embodiment of a data management system 200 configured to store and manage data for the present embodiments. In one embodiment, the system 200 may include a server 102. The server 102 may be coupled to a data-bus 202. In one embodiment, the system 200 may also include a first data storage device 202, a second data storage device 204 and/or a third data storage device 206. In further embodiments, the system 200 may include additional data storage devices (not shown). In such an embodiment, each data storage device 202-206 may host a separate database of information. For example, in some embodiments, each of storage devices 202-206 can store or be configured to store different types of data (e.g., storage device 202 storing patient medical records, storage device 204 storing data related to healthcare providers and their specialties and privileges, storage device 206 storing data related to symptoms and medical procedures, etc.). In some embodiments, storage devices 202-206 may be arranged in a RAID configuration for storing redundant copies of a database or databases (e.g., through synchronous or asynchronous redundancy updates).

In various embodiments, server 102 may communicate with data storage devices 204-210 over a data-bus (illustrated by arrows between server 102 and storage devices 202-206). In such embodiments, the data-bus may comprise a SAN, a LAN, or the like. The communication infrastructure may include Ethernet, Fibre-Channel Arbitrated Loop (FC-AL), Small Computer System Interface (SCSI), and/or other similar data communication schemes associated with data storage and communication. For example, server 102 may communicate indirectly with data storage devices 202-206, (e.g., via a storage server or storage controller 106).

Server 102 may host one or more software applications (e.g., web- and/or Internet-accessible software applications) configured and/or programmed to perform the functions described in this disclosure. The software application may further include modules configured to interface with data storage devices 202-206, network 108, a user (e.g., via a user-interface device 110), and/or the like. In a further embodiment, server 102 may host an engine, application plug-in, or application programming interface (API). In another embodiment, server 102 may host a web service and/or other web accessible software application.

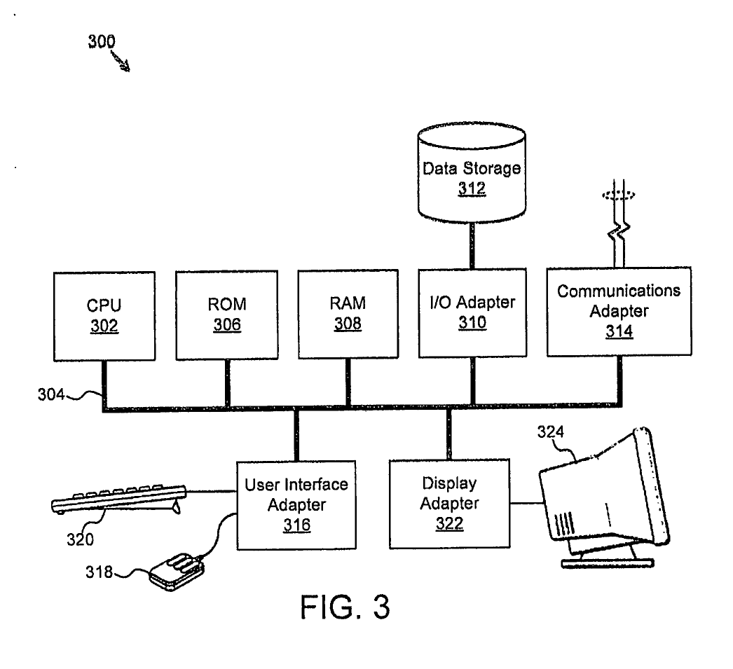

FIG. 3 illustrates a computer system 300 adapted according to certain embodiments of server 102 and/or user interface device 110. Central processing unit (CPU) 302 is coupled to system bus 304. CPU 302 may be a general purpose CPU or microprocessor. The present embodiments are not restricted by the architecture of CPU 302, as long as CPU 302 supports the modules, configurations, and/or operations as described herein. CPU 302 may execute the various logical instructions according to the present embodiments. For example, CPU 302 may execute machine-level instructions according to the exemplary operations described below. Computer system 300 also may include Random Access Memory (RAM) 308, which may be SRAM, DRAM, SDRAM, or the like. Computer system 300 may utilize RAM 308 to store the various data structures used by a software application configured as described in this disclosure. Computer system 300 may also include Read Only Memory (ROM) 306 which may be PROM, EPROM, EEPROM, optical storage, or the like. ROM 306 may store configuration information for booting computer system 300. RAM 308 and ROM 306 may also store user and/or system 100 data.

Computer system 300 may also include an input/output (I/O) adapter 310, a communications adapter 314, a user interface adapter 316, and a display adapter 322. I/O adapter 310, communications adapter 314, and/or interface adapter 316 may, in some embodiments, enable or a user to interact with computer system 300 (e.g., to input information, such as, for example, to update a patient's medical record, respond to a prompt requesting information about characteristics of a patient, or the status of a medical procedure). In a further embodiment, display adapter 322 may display a graphical user interface associated with a software or web-based application.

I/O adapter 310 may connect to one or more storage devices 312, such as one or more of a hard drive, a Compact Disk (CD) drive, a floppy disk drive, a tape drive, to the computer system 300. Communications adapter 314 may be adapted to couple computer system 300 to network 106, which may, for example, be one or more of a LAN, WAN, and/or the Internet. User interface adapter 316 couples user input devices, such as a keyboard 320, a pointing device 318, and a microphone and/or audio speaker, to computer system 300. Display adapter 322 may be driven by CPU 302 to control the display on display device 324.

The present embodiments are not limited to the architecture of system 300. Rather computer system 300 is provided as an example of one type of computing device that may be adapted to perform the functions of a server 102 and/or user interface device 110. For example, any suitable processor-based device may be utilized including without limitation, including personal data assistants (PDAs), computer game consoles, smart phones, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

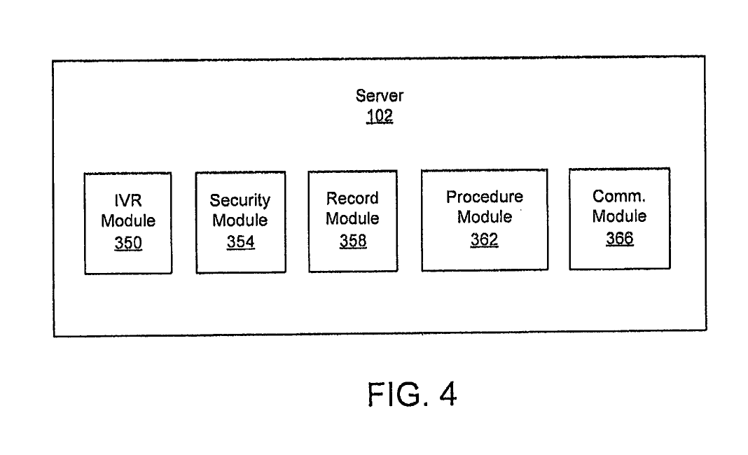

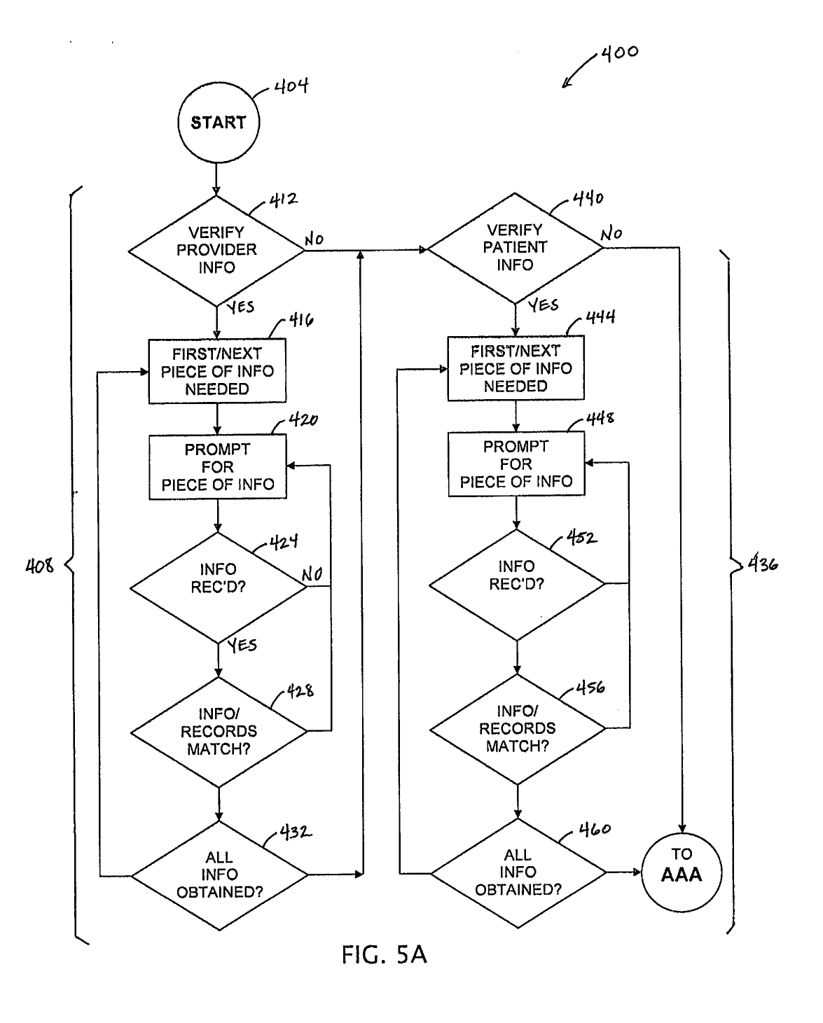

FIG. 4 illustrates a further embodiment of a server 102 for healthcare data verification, instruction, and/or record keeping. In the embodiment shown, server 102 includes a plurality of modules configured to perform the functions described in this disclosure. Although server 102 is described as having a plurality of modules, in some embodiments, such modules are merely conceptual (e.g., such modules are not necessarily distinct physical pieces or segments of code, and may instead be combined into multiple combinations of the modules described, or into a single module that is configured to perform some or all of the functions described). In other embodiments, the modules described may be combined, omitted, and/or substituted in any combination of individual modules and/or functions described. In the embodiments shown, server 102 broadly includes an IVR module 350, a security module 354, a records module 358, a procedure module 362, and a communications module 366.

In the embodiment shown, IVR module 350 is generally configured to convert text to speech, and vice versa (e.g., to recognize voice inputs and convert the voice input into a data format usable by other modules, the server, and/or the one or more electronic storage devices). For example, IVR module may receive data indicative of a step in a medical procedure from procedure module 362 and instruct a user-interface device associated with a medical professional to “speak” (audibly output) an instruction for the step to the medical professional. As a further example, if the medical professional (or another person) provides a voice input confirming performance of the instructed step, then procedure module 362 can convert the voice input into a data format usable by other modules.

In the embodiment shown, security module 354 is generally configured to manage and/or control security and/or access to server 102 (e.g., by one or more user-interface devices). For example, in the embodiment shown, server 102 (e.g., security module 354) is configured to associate each of one or more user-interface devices with one or more medical professionals or other users. For example, server 102 (e.g., security module 354) can be configured to associate each of one or more user-interface devices 110 with a user responsive to receiving from the user-interface device a username and password (or other identifying information) corresponding to the user. Users may include, for example, doctors, nurses, physicians assistants, technicians, hospital or clinical administrators, and/or the like. In some embodiments, security module 354 is configured to permit different levels of access for different users. Some users or types of users may be system administrators with administrator-level access to system 10, such as, for example, permission to read and edit files. Some users may have more-limited access to system 10, such as, for example, permission read and edit only certain files, permission to only read files, etc.

In some embodiments, server 102 (e.g., security module 354) is configured to permit a system administrator to add, delete, modify, activate, inactivate, and/or suspend accounts (e.g., accounts associated with other users) in system 10. Similarly, server 102 can be configured to permit (e.g., receive instructions from) system administrators to add, delete, edit, activate, inactivate, and/or change files or content piece-by-piece and/or across sections (e.g., by individual medical procedure templates, individual medical records, system-wide policies and standards, etc.). Server 102 can associate a user-interface device 110 with a user by any suitable method or function, such as, for example, registering an IP address of the user-interface device, registering a network to which the user-interface device is connected or communicating; registering a tracking cookie to the user-interface device (e.g., a cookie with a predetermined authorization time, such as 1, 2, 6, 12, or 24 hours; or a cookie with without a time limit or expiration, such as for a non-public computer); and/or the like. In some embodiments, server 102 (e.g., security module 354) is configured to: disassociate the user-interface device 110 from a user (or other user with which the user-interface device is associated) responsive to receiving a logout instruction from the user-interface device or a period of inactivity that exceeds a predetermined inactivity threshold (e.g., 5, 10, 30, 60 minutes of inactivity such as not receiving an instruction from the user-interface device). In some embodiments, server 102 (e.g., security module 354) is configured to generate passwords (e.g., temporary passwords) randomly and/or sequentially. For example, in some embodiments, server 102 is configured to generate and/or transmit a temporary password for a new user, and/or to prompt the new user to change the temporary password to a user-defined password (e.g., the first time the new user logs onto or otherwise connects to the system).

In the embodiment shown, records module 358 is generally configured to interface with the one or more storage devices to read, edit, and/or verify data in records corresponding to patients and/or medical professionals. For example, records module 358 can register and/or store one or more characteristics, properties, or pieces of information associated with a patient and/or medical professional. For example, in some embodiments, server 102 (e.g., profile module 358) is configured to receive (e.g., via IVR module 350) instructions from a medical professional (e.g., a nurse, a physician, a hospital administrator, etc.) to define and/or modify one or more characteristics of a medical record corresponding to a patient (e.g., blood pressure, drug allergy, medical condition, etc.), and/or a record corresponding to a medical professional (e.g., capabilities, expertise, certification, privileges, etc.).

In the embodiment shown, procedure module 362 is generally configured to interface with the one or more electronic storage devices to read and/or access data corresponding to various medical procedures. For example, procedure module 362 may access a procedure template for administration of morphine, labor and delivery of a baby, and/or verification of patient and procedure information in an operating room. In one embodiment, the system can be configured such that procedure module interfaces with IVR module 350 to deliver instructions to one or more medical professionals and/or receive information from the one or more medical professionals, and interfaces with records module 354 to access data needed to populate a procedure template for a particular patient, to verify information received in voice inputs from one or more medical professionals, and/or to update records with information received in voice inputs from one or more medical professionals.

In the embodiment shown, communications module 366 is generally configured to communicate with medical professionals that are remote from a procedure being performed in conjunction with the system. For example, if a medical professional performing a procedure provides a voice input that indicates an alarm condition requiring the assistance of medical professionals with different expertise, or that indicates the need for different facilities, communications module 366 can send a message communicating the need for the additional resource (e.g., such that a medical professional with relevant expertise can be summoned to the location of the procedure, and/or such that other personnel can make ready another facility such as an operating room).

In some embodiments, and as further illustrated by the examples below, the system is configured to: prompt one or more users for a plurality of voice inputs with information associated with at least one of a patient and a user; and determine whether each of the plurality of voice inputs is consistent with records related to the patient or the one or more users. Information related to a patient can include, for example, one or more of: an alphanumeric patient identifier associated with the patient, the patient's name, the patient's birthdate, and one or more physical characteristics of the patient, one or more current diagnoses of the patient, one or more past diagnoses of the patient (e.g., the patient's medical history). Information associated with the one or more users can include, for example, one or more of: an alphanumeric identifier associated with a medical professional, a medical professional's name, a medical professional's title, and/or a medical professional's specific role, task, and/or task status (e.g., for a procedure).

In some embodiments, the system is configured to: prompt one or more users for voice input with information associated with each of a plurality of users. In some embodiments, the system is configured to identify which of a plurality of users provided a voice input. For example, the system can be configured to: receive a voice input from each of a plurality of users; and generate for each of the plurality of users a voice print corresponding to the user and configured to be compared to a subsequent voice input to identify the user that provided the subsequent voice input. For example, when a procedure is initiated (e.g., as in Example 3 below), the system can prompt all medical personnel to provide their name, and when receiving each individual's name, generate a voice print (e.g., store certain characteristics such as tone, inflection, etc., of the user's voice to which the system can later refer to identify the user from which subsequent voice inputs originate).

In some embodiments, the system is configured to: prompt one or more users for one or more voice inputs with information relating to whether a procedure should be performed on the patient. Such information may include patient characteristics and/or conditions, such as, for example, height, weight, temperature, heart rate, heart rhythm, blood pressure, respiratory rate, oxygen saturation, intake and output, medication status, “station” of a baby (e.g., during labor), sedation level based on a sedation scale, pain score, and the like. For example, if a user has already identified a procedure to be performed on a patient, the voice inputs may include a reason for performing the procedure and/or patient characteristics indicative of whether the procedure should be performed at the time (e.g., or whether the patient should be allowed to stabilize first). By way of another example, the voice inputs may include patient characteristics that the system can compare to stored or otherwise accessible information indicating procedures to be performed in the event of certain patient characteristics (e.g., deliver epinephrine or a bolus of fluid if heart rate or blood pressure, respectively, drops below a certain threshold during surgery). In some embodiments, the system is configured to prompt one or more users for voice inputs indicative of the progress of a procedure (e.g., “Please confirm that incision is complete.” or “Please confirm delivery of baby”), and/or determine whether progress of the procedure (or lack of progress) indicates that the procedure should be terminated or modified.

The system can thus be configured to perform a near real-time, emotion-free comparison of patient characteristics, procedure progress, and present circumstances (e.g., surgery in progress) and possible procedures, identify one or more procedures that may be indicated by the characteristics, and prompt the one or more users to select a procedure if more than one procedure is indicated. By way of another example, the system can be configured to monitor patient characteristics (e.g., via voice inputs or a direct connection to one or more systems or devices monitoring patient characteristics in real-time) and determine whether a procedure in progress should be modified or terminated due to the patient characteristics (e.g., by comparing those patient characteristics to stored or otherwise accessible information indicative of complications or other reasons a procedure should be terminated that may be indicated by the patient characteristics), and prompt the user(s) to terminate or modify the procedure if indicated.

In some embodiments, the system can be configured to determine whether information indicates an alarm condition and/or otherwise indicates a need for one or more resources that are not present (e.g., a medical professional and/or specialty team of medical professionals, an operating room, a crash cart, an x-ray or other imaging machine, an EKG machine, a medication, blood for transfusion, etc.), and to communicate a request for the one or more resources. In some embodiments, the present systems can be configured to remind one or more medical professionals of elapsed time, and/or automatically perform certain actions after a certain amount of time has elapsed, relative to a temporal reference point (e.g., from an initiating call or event) to help reduce the likelihood of temporal milestones being potentially overlooked or forgotten (e.g., by task-focused and/or stressed medical professionals). For example, in some embodiments, the system is configured to call for one or more additional resources after a certain amount of time has elapsed, whether or not the one or more medical professionals have indicated a need (e.g., if a medical professional has not confirmed delivery or sufficient progress after a triggering event). For example, if five minutes have elapsed after shoulder dystocia has been “called” during delivery of a baby, without a medical professional providing voice and/or other inputs confirming that the baby has been delivered and/or that the baby has been dislodged, then the system can communicate a request to prepare an operating room and/or surgical team for an emergency C-section.

The schematic flow chart diagrams that follow are generally set forth as logical flow chart diagrams. As such, the depicted order and labeled steps are indicative of one embodiment of the present methods. Other steps and methods may be conceived that include the function, logic, or effect within the scope of the claims and/or the present disclosure. Additionally, the format and symbols employed are provided to explain the logical steps of the method and do not to limit the scope of the method or functionality of the present systems that are configured to perform the described functionality. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown, and various ones of the steps may be ordered otherwise in other embodiments.

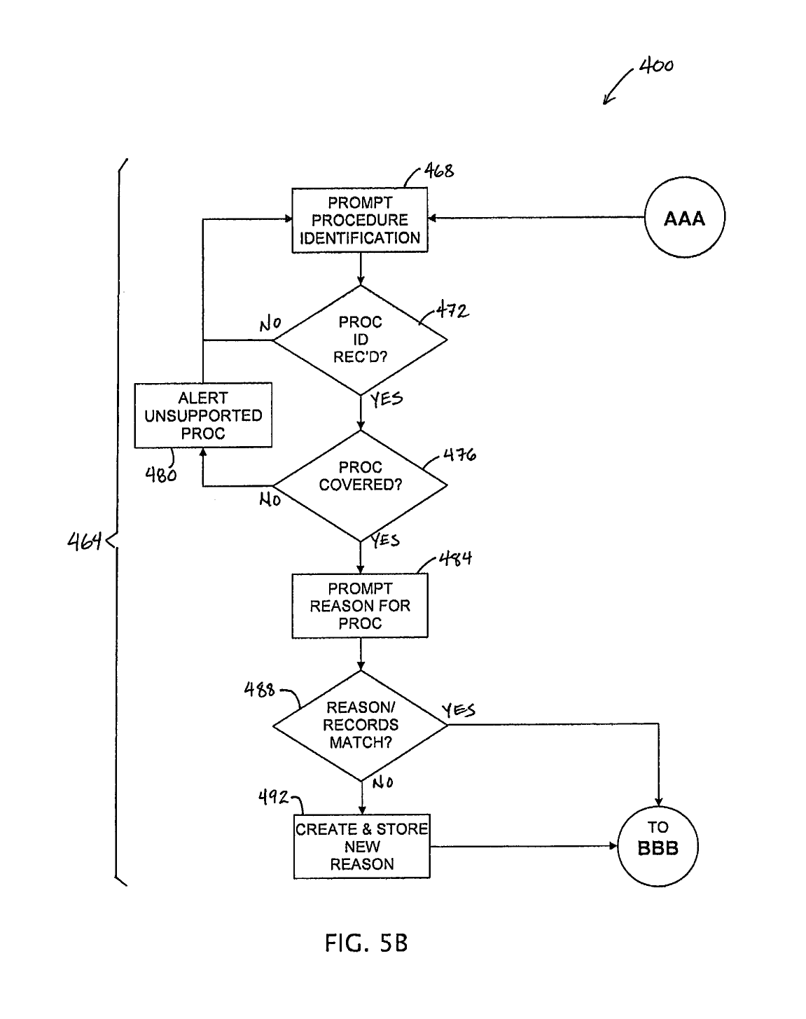

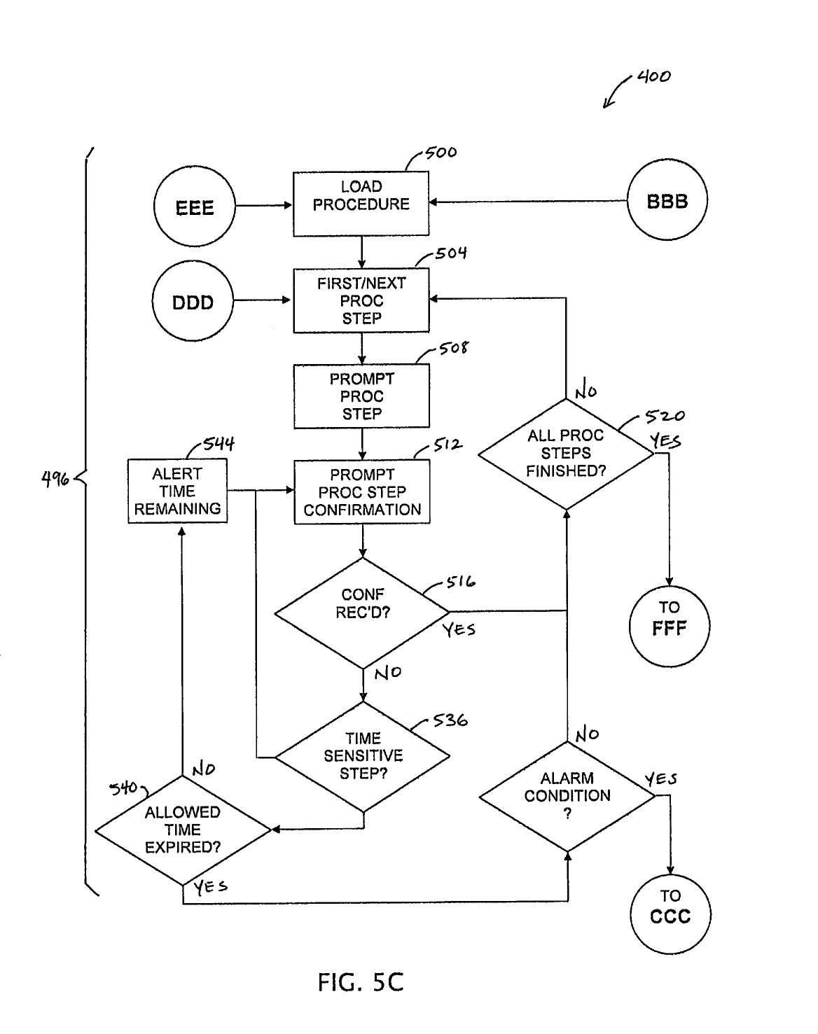

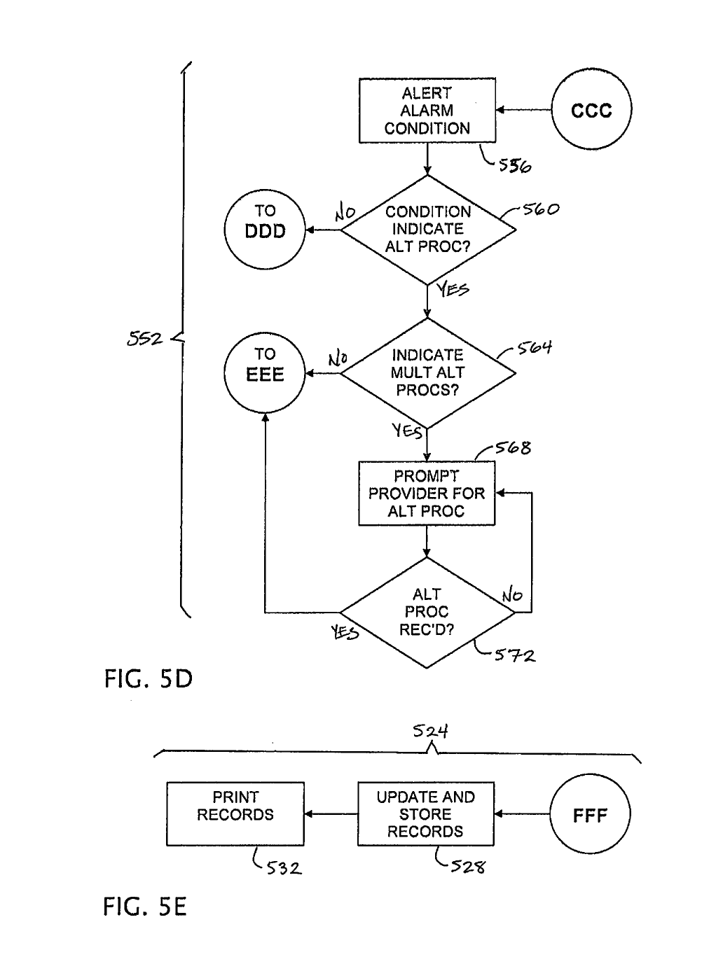

Referring now to FIGS. 5A-5E, shown therein and designated by the reference numeral 400 is a flowchart illustrating an embodiment of the present methods, including functions that can be included (in various combinations) in embodiments of the present systems.

In the embodiment shown, the method begins at a starting block 404, and proceeds to a provider information collection and verification block 408 configured to collect and/or verify information related to one or more medical professionals. Block 408 begins or is initiated at step 412, in which the system determines whether any provider information is needed for collection or verification. If no provider information is needed, the method proceeds to a patient information collection and verification block 436 configured to collect and/or verify patient information. If instead provider information is needed, the method proceeds to step 416 where the system identifies a first piece of information that is needed, or, if a first piece of information has already been acquired and/or verified, a next or subsequent piece of information that is needed. The method then proceeds to step 420 where the system (e.g., a user-interface device) prompts a user (e.g., a medical professional) for the first piece of information. For example, the system can visually or audibly prompt a user to provide an input (e.g., a voice input) indicative of the first piece of information. In some embodiments, if a plurality of users are present or within range of the user-interface device, the system can prompt a specified one of the users for the input (e.g., “Nurse Smith, please provide your identification number.”). Once the system has prompted the user(s) for the piece of information, the method proceeds to step 424 in which the system determines whether the prompted information has been received. If the piece of information has not been received (e.g., after a pre-determined period for response, such as, for example, 5, 10, 15, or more seconds), or if an input provided was unclear or unintelligible, the system returns to step 420 and again prompts the user(s) for the piece of information. If instead the piece of information has been received, the method proceeds to step 428 where, if the information is also reflected in a record corresponding to or associated with a user, the piece of information is compared to the record. If the piece of information does not match or correspond to the record, the system returns to step 420 and again prompts the user for the piece of information. In some embodiments, if the piece of information provided does not match the record after predetermined number of attempts, the method terminates and/or alerts system administrator and/or security personnel of a possible security breach. If instead the piece of information matches or corresponds to the record, then the method proceeds to step 432 in which the system determines whether all required pieces of information have been obtained (e.g., multiple pieces of information for a single user, multiple pieces of information for each of multiple users, or a single piece of information for each of multiple users, or a single piece of information for each of some of multiple users, and multiple pieces of information for each of others of the multiple users).

In some embodiments, when performing the collection of information from medical professionals, the system is configured to save or create a voice print from each user (e.g., medical professionals and/or a patient) such that the system can recognize subsequent commands or voice inputs from any of the users. In such embodiments, the system can, for example, tag and store various voice inputs as originating from one of the users (e.g., for annotation in medical records).

If all needed pieces of provider information have been received and verified, then the method proceeds to patient information collection and verification block 436 configured to collect and/or verify information related to a patient. Bock 436 begins or is initiated at step 440, in which the system determines whether any patient information is needed for collection or verification. If no patient information is needed, the method proceeds a procedure block 464 configured to identify a procedure to be performed and/or a reason for the procedure. If instead patient information is needed, the method proceeds to step 444 where the system identifies a first piece of information that is needed, or, if a first piece of information has already been acquired and/or verified, a next or subsequent piece of information that is needed. The method then proceeds to step 448 where the system (e.g., a user-interface device) prompts a user (e.g., a medical professional) for the first piece of information. In some embodiments, the system can prompt a patient for a piece of information. For example, the system can visually or audibly prompt a user to provide an input (e.g., a voice input) indicative of the first piece of information. In some embodiments, if a plurality of users are present or within range of the user-interface device, the system can prompt a specified one of the users for the input (e.g., “Patient Jones, please provide your social security number.”). Once the system has prompted the user(s) for the piece of information, the method proceeds to step 452 in which the system determines whether the prompted information has been received. If the piece of information has not been received (e.g., after a pre-determined period for response, such as, for example, 5, 10, 15, or more seconds), or if an input provided was unclear or unintelligible, the system returns to step 448 and again prompts the user(s) for the piece of information. If instead the piece of information has been received, the method proceeds to step 456 where, if the information is also reflected in a record corresponding to or associated with a patient, the piece of information is compared to the record. If the piece of information does not match or correspond to the record, the system returns to step 448 and again prompts the user for the piece of information. In some embodiments, if the piece of information provided does not match the record after predetermined number of attempts, the method terminates and/or alerts system administrator and/or security personnel of a possible security breach. If instead the piece of information matches or corresponds to the record, then the method proceeds to step 460 in which the system determines whether all required pieces of information have been obtained (e.g., multiple pieces of information for a single user, multiple pieces of information for each of multiple users, or a single piece of information for each of multiple users, or a single piece of information for each of some of multiple users, and multiple pieces of information for each of others of the multiple users).

If all needed pieces of patient information have been received and verified, then the method proceeds to procedure identification block 464 that is configured to identify a procedure to be performed and/or a reason for the procedure. Bock 464 begins or is initiated at step 468, in which the system prompts a user to identify a procedure to be performed. Once a user provides an input (e.g., a voice input) indicative of a procedure, the method proceeds to step 472 in which the system determines whether the prompted procedure identification has been received. If the piece of information has not been received (e.g., after a pre-determined period for response, such as, for example, 5, 10, 15, or more seconds), or if an input provided was unclear or unintelligible, the system returns to step 468 and again prompts the user(s) for the procedure. If instead the procedure identification has been received, the method proceeds to step 476 where procedure indication is compared to the procedures supported by the system (e.g., procedures for which procedure templates are stored in or accessible to the system), and/or whether the procedure matches or corresponds to a procedure scheduled or indicated in a record associated with the patient. If the procedure is not supported by the system, or does not correspond to a procedure indicated in a record associated with the patient, then the method proceeds to step 480, in which the system alerts the user(s) that the procedure in not supported or is not scheduled, and the method then returns to step 468 and prompts the user(s) to confirm that the user intends (and has authority) to perform an unscheduled procedure or an unsupported procedure (unsupported by the system), or to provide an alternate procedure. If instead the procedure is supported, and/or matches or corresponds to a procedure scheduled or indicated in a record associated with the patient, then the method proceeds to step 484 in which the system prompts a user to provide a reason for the procedure.

As described above, if a reason is not received within a predetermined period of time for response, the system may continue to prompt the user(s) to provide the reason. Once the system receives a reason for the procedure, the method proceeds to step 488 where, if the procedure and a reason for the procedure are already in a record corresponding to or associated with a patient, the reason is compared to the record. If the reason does not match or correspond to the record, the system returns to step 484 and again prompts the user for the reason. If the reason matches or corresponds to the record, then the system stores and indication in a record associated with the patient that the procedure and reason have been verified, and proceeds to a block 496 configured to instruct a user to perform steps of a procedure, verify that steps of a procedure have been performed, and/or monitor progress of a procedure and/or patient characteristics to alert medical professionals to alarm conditions and/or coordinate treatment of or response to such alarm conditions. If instead, there is not a reason in a record associated with the patient, the method proceeds to step 492 in which the system stores the provided reason for the procedure in a record associated with the patient.

Once the reason for the procedure is verified and/or stored, the method proceeds to block 496 configured to instruct a user to perform steps of a procedure, verify that steps of a procedure have been performed, and/or monitor progress of a procedure and/or patient characteristics to alert medical professionals to alarm conditions and/or coordinate treatment of or response to such alarm conditions. Block 496 begins at step 500 in which the system loads data (e.g., a software module and/or procedure template) corresponding to the procedure to be performed. The method then proceeds to step 504 where, the system identifies a first step of the procedure, or, if a first step of the procedure has already been performed, the system identifies a next or subsequent step of the procedure. The method then proceeds to a step 508 where, if the system is configured to prompt the steps of the procedure, the system prompts a user to perform the identified step of the procedure. In some embodiments, if a plurality of users are present or within range of the user-interface device, the system can prompt a specified one of the users to perform the identified step (e.g., “Doctor Smith, please create a Lanz incision for appendectomy.”). Once the system has prompted the user(s) to perform the step, the method proceeds to a step 512 in which the system prompts the user to confirm that the step has been performed. In some embodiments, the system is configured to prompt the user to list or describe any complications or noteworthy information related to the performance of the step.

Once the user is prompted for confirmation that the step has been performed, the method proceeds to step 516, in which the system determines whether the prompted confirmation has been received. If the confirmation has been received, then system proceeds to a step 520 in which the system determines whether all steps of the procedure have been confirmed. If all steps of the procedure have not been confirmed, then the system returns to step 504 in which the system determines the next or subsequent step. If instead all steps of the procedure have been confirmed, the method proceeds to a records block 524 configured to create and/or update a record associated with the patient, and/or print a paper summary of the procedure and/or health record or chart associated with the patient. Block 524 begins at a step 528 in which records corresponding to the patient are created, updated, and/or stored to include an indication of the procedure, steps performed in the procedure, times of steps of the procedure (beginning and/or ending of the steps), and/or various other notes or events related to the procedure. Once the record(s) are complete, the method proceeds to step 532 in which a summary of the procedure, chart, and/or complete patient record or summary of the complete patient record is printed (e.g., in paper form), such as, for example, for review and approval by the medical professionals involved in the procedure.

If instead at step 516, the confirmation has not been received (e.g., after a pre-determined period for response, such as, for example, 5, 10, 15, or more seconds), or if an input provided was unclear or unintelligible, the method proceeds to a step 536 in which the system determines whether the step is time sensitive (e.g., should be performed within a certain period of time from some reference point in time, such as, for example, the completion or confirmation of a prior step, the beginning of the overall procedure, or other temporal reference). If the step is not time sensitive, then the system returns to step 512 and again prompts the user(s) to confirm that the procedure step has been completed. If instead the step is time sensitive, then the system proceeds to step 540 in which the system compares the allowable time to the time elapsed from the temporal reference. If the allowable time has not expired, then the method proceeds to step 544 in which the system alerts the user(s) to the amount of allowable time remaining for performance of the step; and returns to step 512 in which the system again prompts the user(s) to confirm completion of the step. If at step 540, the allowable time has expired, then the method proceeds to a step 548 in which the system determines whether the expiration of time without confirmation indicates an alarm condition. If the expiration of allowable time without confirmation does not indicate an alarm condition, then the system proceeds to step 520, as described above.

If the expiration of allowable time indicates an alarm condition, then the method proceeds to an alarm evaluation block 552 configured to determine whether an alarm condition indicates an alternate procedure, and if so, identify an appropriate alternate procedure. Block 552 begins at a step 556 in which the system alerts the user(s) to the existence of an alarm condition. The method then proceeds to step 560 in which the system determines whether the alarm condition indicates an alternate procedure. If the alarm condition does not indicate an alternate procedure, then the method returns to step 504, as described above. If instead the alarm condition does indicate an alternate procedure, the method proceeds to a step 564 in which the system determines whether the alarm condition indicates more than one alternate procedures (e.g., indicates that there are multiple alternate procedures that may be appropriate for the circumstances). If so, then the method proceeds to a step 568 in which the system prompts the user(s) to provide an input (e.g., a voice input) indicative of which alternate procedure a treating healthcare professional will pursue. Once a user is prompted for an alternate procedure, the method proceeds to step 572, in which the system determines whether the alternate procedure has been received. If the alternate procedure has been received, then the system returns to step 500, as described above. If at step 572, the alternate procedure has not been received (e.g., after a pre-determined period for response, such as, for example, 5, 10, 15, or more seconds), or if an input provided was unclear or unintelligible, the system returns to step 568 and again prompts the user for an alternate procedure.

The following examples illustrate the implementation and use of the foregoing systems and methods in various embodiments. In some embodiments, the system is configured to perform all of the following examples, such as, for example, sequentially (e.g., one at a time for one or more patients), or simultaneously (e.g., simultaneously for multiple patients).

### EXAMPLE 1

### Morphine Administration

Computer: Please state the date and time
Staff: Today is ______, time is ______
Computer: Drug class?
Staff: Opioid.
Computer: RN name please.
Staff: Suzy Creamcheese.
Computer: Patient's name
Staff: Patient's name Lauren Bacall
Computer: Patient's medical record number.
Staff: 12345.
Computer: Name and medical record mismatch, please try again.
Staff: Patient's name Lauren Bacall. Medical record number is 123456.
Computer: Match found. Please specify your location.
Staff: Room 417, 4 North, SMCH.
Computer: Floor and location mismatch, please try again.
Staff: Sorry. Room 417, 4 North, SMCA.
Computer: Floor and location match. Please specify the drug to be administered.
Staff: Morphine.
Computer: Please specify the dosage.
Staff: 2 mg
Computer: What is patient's R. D. R.?
Staff: RDR is 15.
Computer: Patient in red zone. Please confirm notification of charge nurse.
Staff: Charge nurse notified.
Computer: Who's charge nurse today?
Staff: Claudia Clockwurst.
Computer: Patient in red zone. Requires re-check in 15 minutes. Please confirm re-check or you will be notified in 15 minutes.
(no notification is forthcoming. 15 minutes goes by)
Computer: Please confirm re-check of patient.
Staff: Recheck confirmed by Suzy Creamcheese. The time is ______. Second check.
Computer: What is current R. D. R.?
Staff: RDR is 10.
Computer: Patient is in yellow zone. Please confirm charge nurse's agreement to proceed.
Staff: Patient is in yellow zone. Charge nurse agreed to proceed.
Computer: Please verify medication to be administered.
Staff: Morphine.
Computer: Please verify dosage.
Staff: 4 mg.
Computer: Dosage change noted. Please verify your medication and dosage.
Staff: Medication Morphine, dosage 2 mg. Verified.
Computer: Medication and dosage match found for room 417. You may proceed. Patient re-check required within one hour.
(45 minutes goes by)
Computer: Reminder of re-check in 15 minutes.
(60 minutes later)
Computer: Please state your name.
Staff: Suzy Creamcheese.
Computer: Patient's name
Staff: Lauren Bacall.
Computer: Patient's medical record number.
Staff: 123456
Computer: Medication to be administered
Staff: Morphine.
Computer: Verify the dosage
Staff: 2 mg.
Computer: What is patient's R.D.R?
Staff: RDR is 4.
Computer: Patient is in green zone. Please administer medication.
Staff: Thanks! Please print a summary!
Computer: Summary printing!

### EXAMPLE 2

### Shoulder Dystocia Management

Computer: Shoulder dystocia called. It is now ______(time). Please note the time.
Staff: The time is ______.
Computer: Please call for additional help.
Staff: (pushing the call button)—We have a shoulder at room ______. We need help!
Computer: Get a stool!
Staff: Stool is in the room.
Computer: Lower the head of the bed!
Staff: Head of the bed lowered.
Computer: Move patient's buttocks to the edge of the bed!
Staff: OK, let's move her to the edge.
Computer: Please inform patient about the situation.
Staff: Miss, it seems your baby's shoulder is against your pelvic bone. We need to change your position a couple of times and perform some maneuvers to change baby's position, so we can help you deliver your baby.
Computer: Please note the baby's position. Which side is baby's back?
Staff: Baby's back is on my side, I am on the right side of the mother.
Computer: Is the additional team in the room?
Staff: Yes. We are here.
   Charge nurse Nancy Simpson.
   Nurse Patricia Lightsey.
   CA Mark Good
Computer: SBAR please.
Staff: I'm Suzy Creamcheese, her primary nurse. This is Sally Brown, 32 years old, G2 p1. Shoulder dystocia was called by Dr. Swenson. Patient has a history of diabetes. Previous baby weighted 10 pounds. SROM 5 hours ago. She's been pushing for the last 90 minutes. Baby's head delivered just a minute ago. Patient is positioned for maneuvers.
Computer: Is the Team leader identified?
Staff: Yes. Dr. Swenson is the leader.
Computer: Place O2 face mask!
Staff: O2 is on.
Computer: Check the bladder status!
Staff: Bladder is empty.
Computer: Please report fetal heart rate!
Staff: Baseline 110, moderate variability, late decels noticed No prolonged decels. This is Dr. Swenson. Let's do McRoberts.
Computer: McRoberts Maneuver ordered at ______(time). Please identify your role in assisting McRoberts.
Staff: Suzy Creamcheese, on right side, Nancy on left side, flexing mother's hip and pushing back as far as we can. We need to apply suprapubic pressure.
Computer: Suprapubic Pressure ordered at ______(time)
Computer: Please state the direction of the maneuver,
Staff: We are applying pressure from right to left
Computer: Gentle downward traction by doctor!
   Coaching for maternal push!
   It is now one minute from shoulder call
   Please give an update!
Staff: Maternal vital signs ______, Fetal heart rate ______, Station ______.
Computer: Next step?
Staff: Yes.
Computer: Please check the status of OR.
   Please call anesthesia and Neo team
   Please continue to monitor fetal heart rate.
   Doctor, would you consider episiotomy?
Staff: Yes, I may have to.
Computer: Additional teams arrived?
Staff: Not yet.
Computer: Please make another request!
   Please note the time!
Staff: The time is ______.
Computer: It is now 2 minutes from shoulder call.
Computer: Please perform rotational maneuver in any order—Rubin's maneuver, Wood screw maneuver, Barnum maneuver, or Sim's maneuver.
Computer: I did not hear you, doctor. Please repeat your maneuver!
Staff: I'm trying wood screw maneuver.
Computer: Please call out steps.
Staff: I am trying to rotate the baby clockwise.
Computer: Please give an update of maternal condition! Please report fetal heart rate!
Staff: Maternal signs are the same. Fetal heart rate in the 80s.
Computer: Anterior shoulder delivered?
Staff: No.
Computer: Posterior shoulder delivered?
Staff: No.
Computer: It is now three minutes from the shoulder call! Your maneuver time is up! Please proceed to the exit strategy! Please prepare for Zavanelli maneuver
   Prepare for crash c-section!
   Place fetal scalpel electro lead
   Rotate baby's head to OA position
   Place foley!
   Please note the incision time!
Staff: Incision time is ______.
Computer: Time of delivery documented?
   Cord gas ordered?
   Please report Apgar scores!

### EXAMPLE 3

### Operating Room (OR) Procedure Verification

Computer: Welcome to Seton Medical Center OR! Today is ______. The time is ______. Please confirm patient's name, medical record number, and date of birth.
Staff: Patient name is xxxxx xxxxxxx. Medical record number 102030, date of birth Sep. 10, 1924.
Computer: Sorry, this date of birth does not match your medical record number. Please check again!
Staff: Let me look Oh, sorry, I got the date wrong. The date of birth is Sep. 16, 1924.
Computer: Match found. Please confirm the name of the procedure
Staff: Well, everyone knows why we are here. No need to do that.
Computer: Sorry, I did not hear a procedure name, please say the name of the procedure.
Staff: All right, the procedure name is Inguinal Hernia with Mesh.
Computer: Please confirm the site of the procedure
Staff: Left inguinal region.
Computer: The procedure is—Inguinal hernia with mesh, the site of the procedure is—Left inguinal region. Patient's name is xxxxx xxxxxxx. Medical record number is 102030. Are they correct?
Staff: Yes, they are.
Computer: To ensure computer's accuracy, please check the above against your chart.
Staff: This is ______(name)______. Let me read back from the chart. Patient' pre-op notes says, procedure: inguinal hernia with mesh; site: left inguinal region. Patient name: xxxxx xxxxxxx. Date of birth: Sep. 16, 1924. All confirmed.
Computer: Good. Is patient's consent in the chart?
Staff: Yes.
Computer: Please confirm Anesthesia safety check is completed
Staff: Yes.
Computer: Is Pulse Oximetry on the patient?
   Staff: Yes.
Computer: Does patient have any known allergy?
Staff: No. This is Dr. Wright, the surgeon. Patient has no known allergy.
Computer: Does patient have a difficult air way?
Staff: No. Everything is fine.
Computer: Do you anticipate blood loss more than half a liter?
Staff: No.
Computer: Is team in the room?
Staff: Yes.
Computer: Please identify your role!
Staff: Circulator: John Goss
   Surgeon: Timothy Wright
   Scrub Tech: James Goodman
   Anesthesiologist: George Goofy
   Surgical Tech: Fanny Fox
   Nurse: Nancy Thompson
Computer: Doctor, do you anticipate any critical events or steps?
Staff: No. This is a routine procedure for a healthy patient.
Computer: Anesthesia, do you anticipate any problems?
Staff: No, I'm in agreement with Dr. Wright.
Computer: Antibiotics given?
Staff: Yes, I'll confirm. A gram of Ancef was in 10 minutes ago.
Computer: Do you need imaging?
Staff: No, no imaging needed.
Computer: Thanks. Team, please proceed.
Staff: Please print the checklist!

The various illustrative embodiments of devices, systems, and methods described herein are not intended to be limited to the particular forms disclosed. Rather, they include all modifications and alternatives falling within the scope of the claims. For example, a system configured to prompt one or more users for a plurality of voice inputs, can also be configured to prompt one or more users for one or more non-voice inputs (e.g., via keyboard, touchscreen display, mouse or other indicator, and/or the like).

The claims are not intended to include, and should not be interpreted to include, means-plus- or step-plus-function limitations, unless such a limitation is explicitly recited in a given claim using the phrase(s) “means for” or “step for,” respectively.

1. A system comprising:
a memory;
a processor coupled to the memory;
a user interface coupled to the processor, the user interface configured to receive voice inputs from a user;
where the system is configured to:
prompt one or more users for a plurality of voice inputs with information associated with at least one of a patient and a user; and
determine whether each of the plurality of voice inputs is consistent with records related to the patient or the one or more users.

2. The system of claim 1, where the information related to a patient includes at least one of: an alphanumeric patient identifier associated with the patient, the patient's name, the patient's birthdate, and one or more physical characteristics of the patient.

3. The system of claim 1, where the system is configured to:
prompt one or more users for voice input with information associated with each of a plurality of users.

4. The system of claim 3, where the system is configured to identify which of a plurality of users provided a voice input.

5. The system of claim 4, where the system is configured to:
receive a voice input from each of a plurality of users; and
generate for each of the plurality of users a voice print corresponding to the user and configured to be compared to a subsequent voice input to identify the user that provided the subsequent voice input.

6. The system of claim 1, where the information associated with the one or more users includes at least one of: an alphanumeric identifier associated with a medical professional, a medical professional's name, and a medical professional's title.

7. The system of claim 1, where the system is configured to:
prompt one or more users for one or more voice inputs with a procedure to be performed on the patient.

8. The system of claim 7, where the system is configured to:
determine whether the indicated procedure is consistent with a planned procedure stored in a record related to the patient; and
if the procedure indicated is not consistent, prompt the one or more users for one or more additional voice inputs with the procedure.

9. The system of claim 8, where the system is configured to:
prompt the one or more users for one or more voice inputs with a reason for the procedure.

10. The system of claim 1, where the system is configured to:
prompt one or more users for one or more voice inputs with information relating to whether a procedure should be performed on the patient.

11. The system of claim 1, where the prompted information includes patient characteristics.

12. The system of claim 10, where the system is configured to:
determine whether the information indicates that the procedure should be performed; and
if the information indicates that the procedure should not be performed on the patient, alert the provider that the information indicates that the procedure should not be performed.

13. The system of claim 1, where the system is configured to:
during performance of a procedure on the patient, prompt the user to provide a plurality of voice inputs with information related to progress of the procedure or characteristics of the patient.

14. The system of claim 13, where the system is configured to:
evaluate whether the information related to progress of the procedure or characteristics of the patient indicates that the procedure should be modified or terminated.

15. The system of claim 13, where the system is configured to:
prompt one or more users to perform each of a plurality of steps of the procedure on a patient.

16. The system of claim 14, where the system is configured to:
prompt the user to modify or terminate the procedure if the information related to progress of the procedure or characteristics of the patient indicate that the procedure should be modified or terminated.

17. A system comprising:
a memory;
a processor coupled to the memory;
a user interface coupled to the processor, the user interface configured to receive voice inputs from a user;
where the system is configured to:
during performance of a procedure on a patient, prompt one or more users to provide a plurality of voice inputs with information related to progress of the procedure or characteristics of the patient.

18. The system of claim 17, where the system is configured to:
prompt the user to perform each of a plurality of steps of the procedure.

19. The system of claim 17, where the system is configured to:
evaluate whether the information related to progress of the procedure or characteristics of the patient indicates that the procedure should be modified or terminated.

20. The system of claim 19, where the system is configured to:
if the information indicates that the procedure should be modified, prompt the user to perform a modified procedure; and
if the information indicates that the procedure should be terminated, evaluate whether the information indicates that an alternate procedure should be performed.

21. The system of claim 20, where the system is configured to:
if the information indicates that an alternate procedure should be performed, and that more than one alternate procedures may be indicated, prompt one or more users to provide a voice input with an alternate procedure to be performed; and
if the information indicates that an alternate procedure should be performed, and that only one alternate procedure is indicated, prompt one or more users to perform the alternate procedure.

22. The system of claim 18, where the system is configured to:
evaluate whether the information indicates and alarm condition; and
if the information indicates an alarm condition that indicates a need for one or more resources that are not present, communicate a request for the one or more resources.

23. The system of claim 22, where the resource includes at least one of a medical professional, an operating room, and a medication.

24. The system of claim 17, where the system is configured to:
prompt one or more users for voice input with information associated with each of a plurality of users.

25. The system of claim 24, where the system is configured to identify which of a plurality of users provided a voice input.

26. The system of claim 25, where the system is configured to:
receive a voice input from each of a plurality of users; and
generate for each of the plurality of users a voice print corresponding to the user and configured to be compared to a subsequent voice input to identify the user that provided the subsequent voice input.
